(19) United States
(12) Patent Application Publication
(10) Pub. No.: US 2018/0334832 A1
(43) Pub. Date: Nov. 22, 2018

(54) PROGRAMMABLE LOCK

(71) Applicant: Thomas Smyth, Princeton (CA)

(72) Inventors: Thomas Smyth, Princeton (CA); Michael Harvey, North Vancouver (CA); Greg Henderson, Nelson (CA)

(73) Assignee: Thomas Smyth, Princeton (CA)

(21) Appl. No.: 15/597,048

(22) Filed: May 16, 2017

(51) Int. Cl. E05B 27/00

(52) U.S. Cl. CPC E05B 27/005; E05B 27/0053; E05B 27/00; E05B 27/0017; E05B 27/0082

(57) ABSTRACT

An apparatus for selectably unlocking a door comprises a base adapted to be mounted within a door, an outer cylinder selectably rotatable relative to the base, the outer cylinder having an central bore therethrough and an inner cylinder selectably rotatably received within the inner bore of the outer cylinder. The inner cylinder has a key slot therethrough and is adapted to unlock a door upon rotation of the inner cylinder. The apparatus further includes a plurality of tumblers extending between the inner and outer sleeves alignable upon insertion of a specific key within the key slot so as to permit rotation of the inner cylinder within the central bore a means for identifying a key inserted within the key slot as an authorized key and a latch operable to selectably couple the outer cylinder to the base wherein the latch uncouples the outer cylinder from the base when an authorized key is located within the key slot.

### BACKGROUND OF THE INVENTION

### 1. Field of Invention

The present invention relates generally to lock and key devices and specifically to a programmable lock.

### 2. Description of Related Art

Keys are used for many purposes, and each purpose typically utilizes a unique key, requiring a person to carry several keys at once. For example, keys may be used for vehicles, houses, offices, storage lockers, and other secure areas. When a person needs access to a variety of secure areas or items, they may carry many keys at once, which can be cumbersome.

Key cards or passwords may be used in cases where users are granted conditional access to a secure area. Key cards can be set to expire after a specified amount of time, but require for the lock card reader to be integrated with a central system, and additional technology is required to write and erase the key cards. Disadvantageously, it is also possible for programmable key cards to lose their data over time or to lose data if they are placed in close proximity to a magnetic field.

It is often necessary to rekey or replace a traditional lock, which can be costly and time consuming. When a traditional lock is compromised by the loss of a key, it is customary to replace the lock or rekey the lock and cut new keys. The lock may also be rekeyed or replaced for peace of mind when new users or owners take control over a lock system.

Existing alternatives to traditional lock systems require knowledge of electronics and programming, rendering them too complicated for the average residential user. Additionally, support is limited as the typical locksmith is not familiar with these systems.

Other locks programmable to accept a variety of keys are available. Examples include U.S. Pat. No. 6,318,137 B1 to Chaum and U.S. Pat. No. 8,581,690 B2 to Lappalainen et al. Disadvantageously, these locks require power to operate, and cannot be mechanically opened when power fails.

### SUMMARY OF THE INVENTION

According to a first embodiment of the present invention there is disclosed an apparatus for selectably unlocking a door comprising a base adapted to be mounted within a door, an outer cylinder selectably rotatable relative to the base, the outer cylinder having an central bore therethrough and an inner cylinder selectably rotatably received within the inner bore of the outer cylinder. The inner cylinder has a key slot therethrough and is adapted to unlock a door upon rotation of the inner cylinder. The apparatus further includes a plurality of tumblers extending between the inner and outer sleeves alignable upon insertion of a specific key within the key slot so as to permit rotation of the inner cylinder within the central bore a means for identifying a key inserted within the key slot as an authorized key and a latch operable to selectably couple the outer cylinder to the base wherein the latch uncouples the outer cylinder from the base when an authorized key is located within the key slot.

The inner and outer cylinders may be rotatable about a common axis. Each of the plurality of tumblers may comprise pin tumblers comprises a key pin located within a pin bore extending radially outward through the inner cylinder and a selectably alignable driver pin located within a driver pin bore extending radially inward into the central bore of the outer cylinder. Each key pin may be displaceable by the key within the key slot.

The means for identifying may comprise at least one sensor adapted to read a profile of the key inserted into the key slot. The sensor may comprise position sensors disposed on each driver pin to measure a position of the plurality of tumblers as determined by the profile of the key inserted into the key slot.

The apparatus may further comprise a processing circuit having an associated memory, the processing circuit being adapted to receive the position of each of the at least one sensor, compare the measured profile against a plurality of authorized key profiles contained within the associated memory and identify the key inserted within the key slot as an authorized key if the profile matches one of the plurality of authorized key profiles contained within the associated memory. The processing circuit may be further adapted to cause the latch to uncouple the outer cylinder and the base.

The latch may comprise a pin slidably extendable from the base into a radial bore within the outer cylinder. The latch may include a solenoid adapted to retract the pin from engagement within the radial bore upon receipt of a signal from the processing circuit indicating that the key is an authorized key. The processing circuit may be further adapted to cause the latch to uncouple the outer cylinder and the base only if all criteria for that authorized key are satisfied.

According to a further embodiment of the present invention there is disclosed a method for selectably unlocking a lock comprising reading a key inserted into a slot within an inner cylinder wherein the inner cylinder is received within an outer cylinder supported by and selectably lockable relative to a base, wherein the inner cylinder is operably connected to a lock catch so as to cause the lock to be unlocked in response to rotation of the inner cylinder and identifying the key as one of a specific key, an authorized key or an unauthorized key. The method further comprises, if the key is a specific key, permitting the inner cylinder to rotate relative to the outer cylinder, wherein the inner cylinder is rotatably fixed relative to the outer cylinder if the key is not a specific key, if the key is an authorized key, permitting the outer cylinder to rotate relative to the base and rotatably fixing the inner cylinder and the outer cylinder to the base if the key is an unauthorized key.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is an external perspective view of a door having a programmable lock installed thereon according to a first embodiment of the present invention.

FIG. 2 is a perspective view of the door of FIG. 1, as seen from the interior side thereof.

FIG. 3 is a perspective view of the lock of FIG. 1.

FIG. 4 is an exploded perspective view of the lock of FIG. 1.

FIG. 5 is a cross-sectional view of the lock of FIG. 3, taken along the plane 5-5.

FIG. 6 is a cross-sectional view of the plug, as taken along the line 6-6 of FIG. 5.

FIG. 7 is a schematic diagram of the electronic control system.

FIG. 8 is a flowchart of a method for unlocking a door utilizing the lock of FIG. 1.

### DETAILED DESCRIPTION

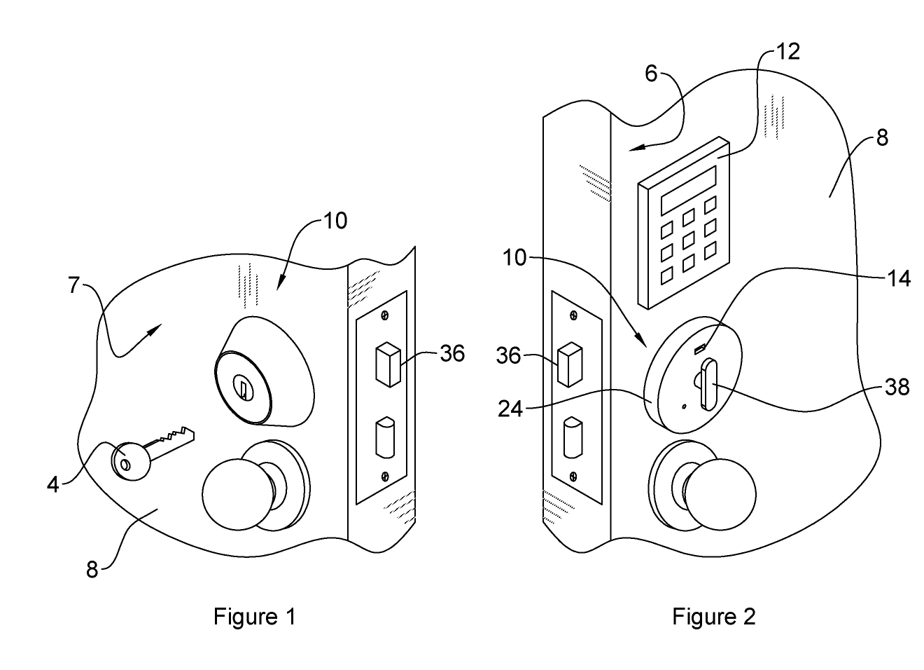

Referring to FIGS. 1, 2 and 3, a programmable lock according to a first embodiment of the invention is shown generally at 10. The lock 10 may be installed within a door 8, having exterior and interior surfaces, 7 and 6, respectively. The lock 10 may be programmed to accept a variety of standard keys 4 using an optional control panel 12 or through an interface access 14, installed on the interior surface 6 of the door 8.

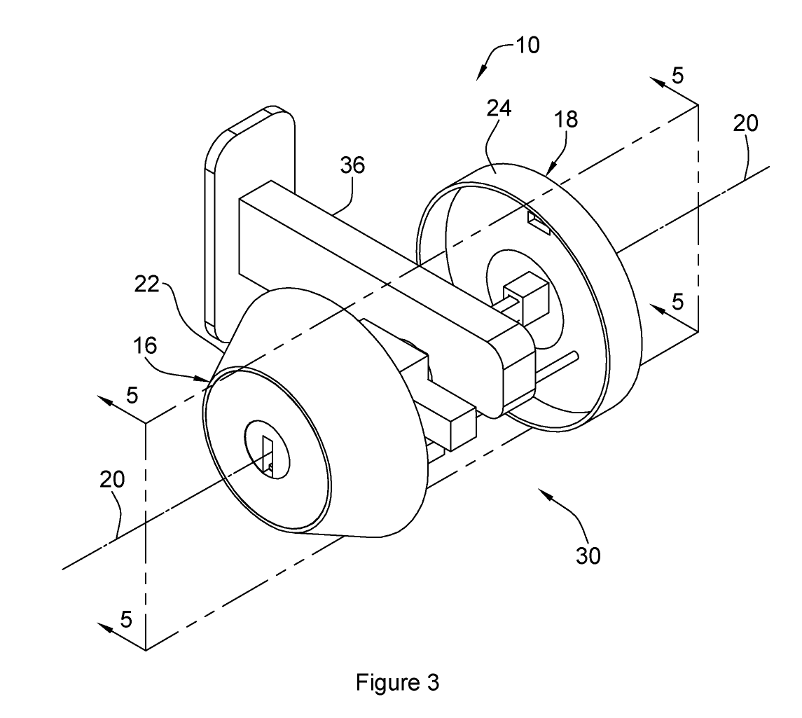

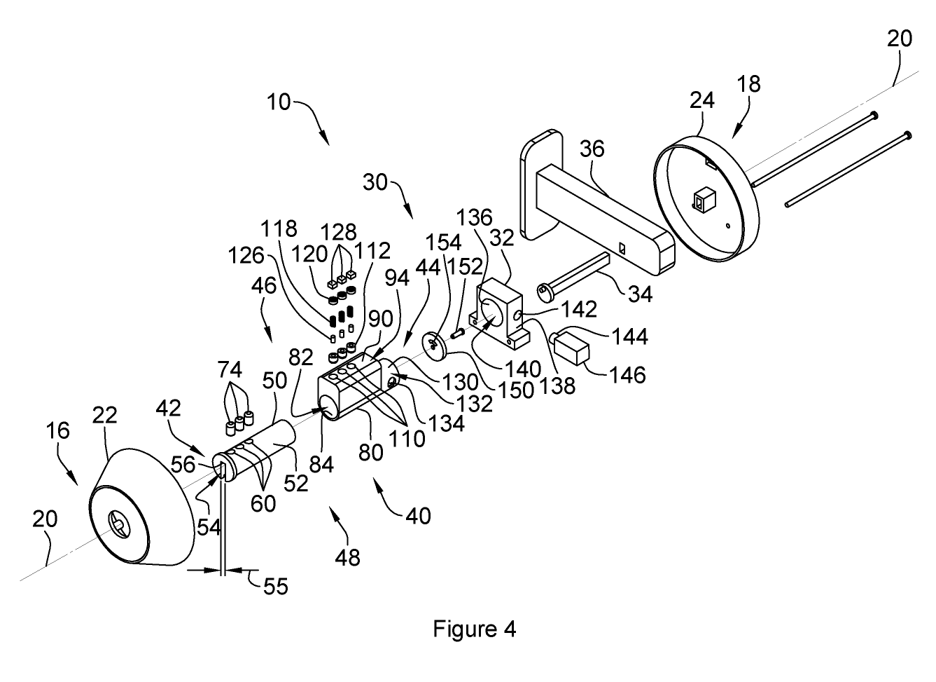

Referring to FIGS. 3 and 4, the lock 10 extends between exterior and interior ends, 16 and 18, respectively, along an axis 20. The lock includes an exterior housing 22 of any desired shape proximate to the exterior end 16 and a interior housing 24 proximate to the interior end 18, with a locking assembly 30 therebetween.

As illustrated on FIG. 4, the locking assembly 30 includes a cylinder assembly 40 adapted to be received within a base 32. When an accepted key 4 is inserted into the lock 10, the cylinder assembly 40 may rotate about the axis 20, as will be set out further below. When the cylinder assembly 40 is rotated, a tailpiece 34 moves a deadbolt 36 into a locked or unlocked position, as is commonly known by one skilled in the art. As seen on FIG. 2, a turn-knob 38 located on the interior housing 24 at the interior end 18 is also connected to the tailpiece 34, and may operate the deadbolt 36 from the inside of the door 8 without the use of a key 4, as is commonly known in the art.

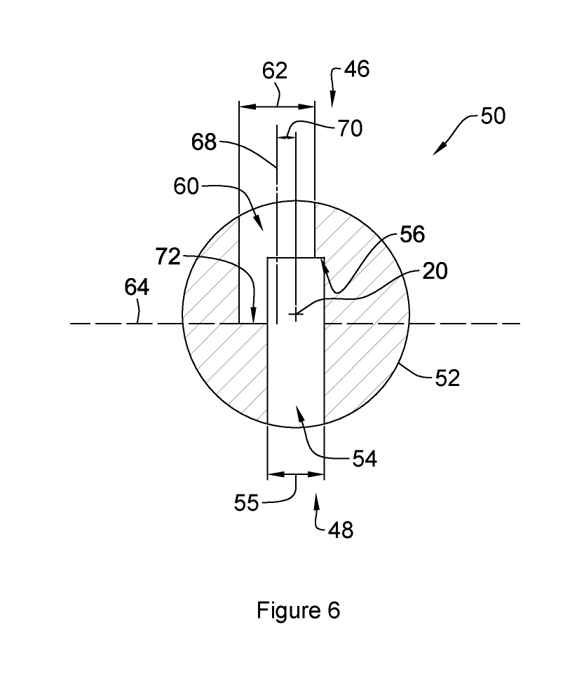

Turning to FIGS. 4, 5 and 6, the cylinder assembly 40 extends between first and second ends, 42 and 44, respectively, along the axis 20, with top and bottom, 46 and 48, respectively. The cylinder assembly 40 includes a cylindrical plug 50 adapted to be received within an outer housing 80. The plug 50 has an outer surface 52 and includes a centered axial key slot 54 with a slot width 55 sized to accept a key 4 therein. The key slot 54 extends through the outer surface 52 of the plug 50 from the bottom 48 to a slot top 56 and between the first end 42 and a slot second end 58.

A plurality of cylindrical key pin bores 60, having pin bore diameters 62, each extend along an axis 68, which may be offset from the axis 20 by an offset distance 70, through the outer surface 52 of the plug 50 from the top 46 to a key pin bore bottom plane 64, forming key pin stop surfaces 72 along the key pin bore bottom plane 64. The key pin bores 60 intersect the key slot 54. The location of the key pin bore bottom plane 64 is selected to match an inserted key 4 cut to a maximum depth, as is commonly known. The pin bore diameter 62 may be greater than the slot width 55, as illustrated in the current embodiment. Although the present embodiment illustrates three key pin bores 60, it will be appreciated that additional key pin bores 60 may be useful, as well.

The plug 50 may include, such as, by way of non-limiting example, a range of between 3 and 6 key pin bores 60.

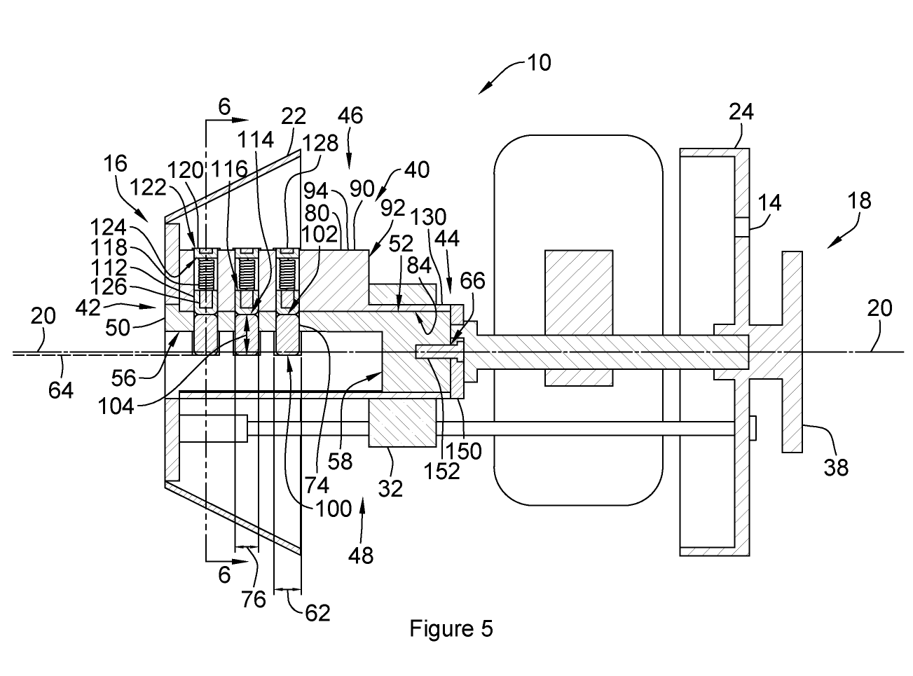

Each key pin bore 60 contains a cylindrical key pin 74 therein. Each key pin 74 extends between a bottom 100 and a top 102, and has a diameter 76, smaller than the pin bore diameter 62, allowing movement along each axis 68 therein. Each key pin 74 may have a curved profile at the top 102, as best seen in FIG. 5. Without a key in the slot, each key pin 74 is located with a key pin bore 60 such that the bottom 100 engages upon the key pin stop surface 72, and the top 102 is at or below the outer surface 52 of the plug 50. Each key pin 74 has a height 104 between the bottom 100 and the top 102. The height 104 of each key pin 74 is selected such that when a specific key is inserted into the lock 10, the top 102 of each key pin 74 is in alignment with the outer surface 52 of the plug 50, therefore allowing the plug 50 to rotate relative to the outer housing 80 about the axis 20, as will be described further below. It will be appreciated that the height 104 of each key pin 74 is dependent on the cut of the specific key, and each key pin 74 may have a different height 104.

A threaded axial mounting hole 66 extends from the second end 44 along the axis 20 and is sized to receive a mounting screw 152, as will be set out below.

Referring to FIGS. 4 and 5, the outer housing 80 extends between the first and second ends 42 and 44, and includes a pin housing portion 90 and a latching portion 130, with a cylindrical passage 82 extending along the axis 20 therethrough. The cylindrical passage 82 includes an inner surface 84 and is sized to receive the plug 50 therein with a slip fit such that the plug 50 may rotate relative to the outer housing 80 about the axis 20.

The pin housing portion 90 extends from the first end 42 to a housing end 92, and has a top surface 94. A plurality of cylindrical driver pin bores 110, having pin bore diameters 62, extend along the axis 68, as set out above, through the top surface 94 of the pin housing portion 90 to the inner surface 84, forming a passage to the cylindrical passage 82. When the plug 50 is inserted within the outer housing 80, the driver pin bores 110 are aligned with the key pin bores 60, as best illustrated in FIG. 5. Although the present embodiment illustrates three driver pin bores 110, it will be appreciated that additional driver pin bores 110 may be useful, as well. The outer housing 80 may include, such as, by way of non-limiting example, a range of between 3 and 6 driver pin bores 110.

Each driver pin bore 110 contains a cylindrical driver pin 112 therein. Each driver pin 112 extends between a bottom 114 and a top 116, and has a diameter 76, smaller than the bore diameter 62, allowing movement along each axis 68 therein. Each driver pin 112 may have a curved profile at the bottom 114, as best seen in FIG. 5. The bottom 114 of each driver pin 112 is engaged upon the top 102 of the key pin 74 in the aligned key pin bore 60 therebelow. A compression spring 118 is contained within each driver pin bore 110 above the driver pin 112, and engages upon the top 116 of each driver pin 112. Each driver pin bore 110 is sealed with a pin bore cap 120, having top and bottom surfaces, 122 and 124, respectively. The pin bore cap 120 may be secured by any known means, such as, by way of non-limiting example, a threaded connection between the pin bore cap 120 and the driver pin bore 110. The compression spring 118 is engaged between the bottom surface 124 of the pin bore cap 120 and the top 116 of the driver pin 112, forcing the driver pin against the associated key pin 74, while allowing upwards movement therein when a key 4 is inserted into the lock 10.

When the height 104 of the associated key pin 74 is such that the top 102 of the key pin 74 is below the outer surface 52 of the plug 50 when the key pin 74 is engaged upon the key pin stop surface 72, the driver pin 112 is contained within both the key pin bore 60 and the driver pin bore 110, preventing the plug 50 from rotating about the axis 20 relative to the outer housing 80. As set out above, when a specific key is inserted into the lock 10, the top 102 of each key pin 74, and thus the bottom 114 of each associated driver pin 112, is in alignment with the outer surface 52 of the plug 50 and the inner surface 84 of the outer housing 80, forming a shear line, as is commonly known, therefore allowing the plug 50 to rotate relative to the outer housing 80 about the axis 20 and unlocking the lock, as is commonly known.

A permanent magnet 126 may be contained within each driver pin 112. The magnets 126 may be axially charged permanent magnets. The magnets 126 may be rare earth magnets, such as neodymium and samarium-cobalt magnets, by way of non-limiting example as are commonly known, although other types of magnets such as ferromagnetic permanent magnets may be useful, as well. A sensor 128 may be contained within the top surface 122 of each pin bore cap 120. Each sensor 128 may be a Hall Effect sensor, as is commonly known, which senses the position of the associated magnet 126 therebelow, the purpose of which will be set out further below. It will be appreciated that other types of sensors, such as membrane potentiometers, may be useful, as well.

The cylindrical latching portion 130 of the outer housing 80 extends from the housing end 92 to the second end 44 and has an outer surface 132. A latching hole 134 extends radially through the latching portion 130 from the outer surface 132 to the inner surface 84, as best seen on FIG. 4. The base 32 has inner and outer surfaces, 136 and 138, respectively, and includes a cylindrical passage 140 along the axis 20 therethrough. The cylindrical passage 140 is sized to receive the latching portion 130 therein, with a slip fit such that the outer housing 80 may rotate relative to the base 32 about the axis 20.

The base 32 includes a base latching hole 142 therethrough, extending between the inner and outer surfaces, 136 and 138. The base latching hole 142 is sized and located to align with the latching hole 134 on the outer housing 80. A latch 144, sized to be received within both the base latching hole 142 and the latching hole 134, extends from the outer surface 138 therethrough, preventing the outer housing 80 from rotating within the base 32. A pull solenoid 146, as is commonly known, may be activated to withdraw the latch 144, thereby allowing the outer housing 80 to rotate about the axis 20 within the base 32. Although a pull solenoid is illustrated in the present embodiment to withdraw the latch 144, it will be appreciated that other methods may be used to withdraw the latch 144, as well.

A circular interface plate 150 is secured along the axis 20 to the second end 44 of the plug 50 with the mounting screw 152 engaged within the mounting hole 66. An arcuate slot 154 extends through the interface plate 150. The tailpiece 34 is engaged within the slot 154 and through the deadbolt 36 to the interior housing 24. Although the tailpiece 34 is illustrated as being mounted to the plug 50 with a mounting screw 152, it will be appreciated that other methods of connecting the tailpiece 34 to the plug 50, such as, by way of non-limiting example, crimping may be used as well, as is commonly known in the art. The purpose and operation of these parts is commonly known within the art, and will not be described further herein.

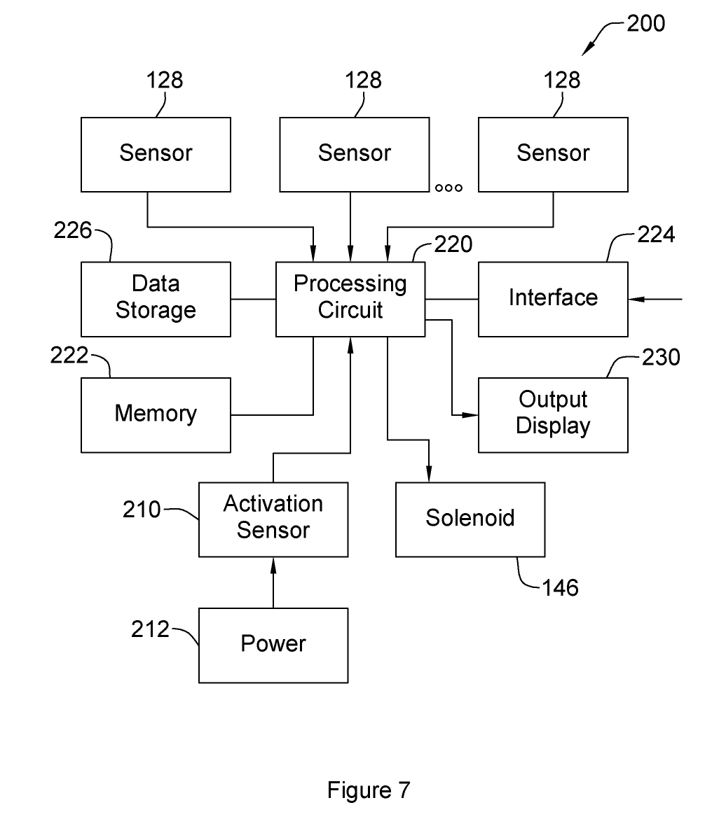

Turning now to FIG. 7, the lock 10 includes an electronic control system 200. When an activation sensor 210 is activated, such as by the insertion or attempted rotation of a key 4 within the lock 10, power 212 is supplied to the control system 200. Power 212 is only supplied while the activation sensor 210 is activated, thereby reducing energy requirements when in a passive state. It will be appreciated that such activation sensor 210 may comprise a hall effects sensor or the like adapted to sense the presence of a key proximate thereto or in within the lock 10. The control system 200 comprises a processing circuit 220 and memory 222 that stores machine instructions that, when executed by the processing circuit 220, cause the processing circuit 220 to perform one or more of the operations and methods described herein. The processing circuit 220 may optionally contain a cache memory unit for temporary local storage of instructions, data, or computer addresses. The control system 200 further includes a data storage 226 of any conventional type operable to store a plurality of entries containing the information for a plurality of keys and may optionally include an output display 230 for displaying inputs from a database manager or user. The control system 200 also includes an interface 224 such as a radio transmitter, ethernet adapter, USB connection or the like for providing communication between the database manager and the processing circuit 220 and data storage 226. As illustrated in FIG. 2, the interface 224 may be accessed through the interface access 14 or through the optional control panel 12. The control system also includes a plurality of sensors 128 to communicate inputs from a key to the processing circuit 220, and a solenoid 146, which may be controlled with the processing circuit 220.

More generally, in this specification, including the claims, the term “processing circuit” is intended to broadly encompass any type of device or combination of devices capable of performing the functions described herein, including (without limitation) other types of microprocessing circuits, microcontrollers, other integrated circuits, other types of circuits or combinations of circuits, logic gates or gate arrays, or programmable devices of any sort, for example, either alone or in combination with other such devices located at the same location or remotely from each other. Additional types of processing circuit(s) will be apparent to those ordinarily skilled in the art upon review of this specification, and substitution of any such other types of processing circuit(s) is considered not to depart from the scope of the present invention as defined by the claims appended hereto. In various embodiments, the processing circuit 220 can be implemented as a single-chip, multiple chips and/or other electrical components including one or more integrated circuits and printed circuit boards.

Computer code comprising instructions for the processing circuit(s) to carry out the various embodiments, aspects, features, etc. of the present disclosure may reside in the memory 222. In various embodiments, the processing circuit 220 can be implemented as a single-chip, multiple chips and/or other electrical components including one or more integrated circuits and printed circuit boards. The processing circuit 220, together with a suitable operating system, may operate to execute instructions in the form of computer code and produce and use data. By way of example and not by way of limitation, the operating system may be Windows-based, Mac-based, or Unix or Linux-based, among other suitable operating systems. Operating systems are generally well known and will not be described in further detail here.

Memory 222 may include various tangible, non-transitory computer-readable media including Read-Only Memory (ROM) and/or Random-Access Memory (RAM). As is well known in the art, ROM acts to transfer data and instructions uni-directionally to the processing circuit 220, and RAM is used typically to transfer data and instructions in a bi-directional manner. In the various embodiments disclosed herein, RAM includes computer program instructions that when executed by the processing circuit 220 cause the processing circuit 220 to execute the program instructions described in greater detail below. More generally, the term “memory” as used herein encompasses one or more storage mediums and generally provides a place to store computer code (e.g., software and/or firmware) and data that are used by the control system 200. It may comprise, for example, electronic, optical, magnetic, or any other storage or transmission device capable of providing the processing circuit 220 with program instructions. Memory 222 may further include a floppy disk, CD-ROM, DVD, magnetic disk, memory chip, ASIC, FPGA, EEPROM, EPROM, flash memory, optical media, or any other suitable memory from which processing circuit 220 can read instructions in computer programming languages.

As set out above, the data storage 226 stores information for a plurality of keys. The information may be populated within the data storage 226 by any means as is commonly known in the art. The information within the data storage may also be edited, such as conditional settings added or authorized keys removed, by any means as is commonly known in the art. The information within the data storage may be encrypted or protected by a password or the like, as is commonly known in the art, limiting access to the key data and securing against data theft. It will also be appreciated that the processing circuit may be programmed to only permit access to the information within the data storage when a particular key is inserted into the lock. The specific key, which creates a shear line between the key pins 74 and the driver pins 112 as set out above and as commonly known in the art, may override the settings in the data storage 226 as the specific key may unlock the lock 10 under any circumstance.

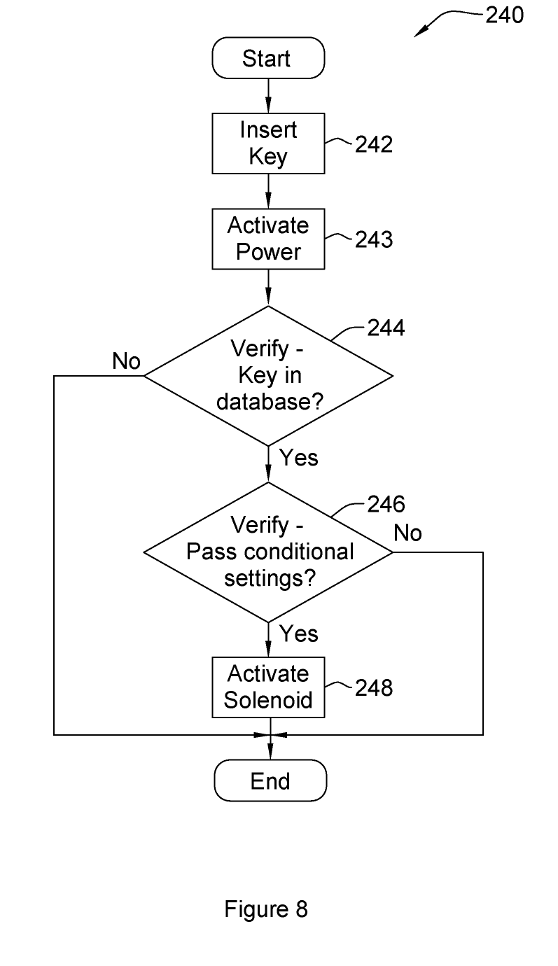

When a key 4 is inserted into the lock 10, the sensors 128 determine the cut of the key 4 and send information to the processing circuit 220 to compare with the data in the data storage 226. In particular, as illustrated in FIG. 8, a method of operating the lock 10 is illustrated generally at 240. The method comprises inserting a key 4 into the lock 10 at step 242. The activation sensor 210 recognizes that a key 4 has been received within the lock 10, and power 212 is supplied to the system at step 243. The sensors 128 send information to the processing circuit 220 and verify if the key 4 is within the data storage 226 at step 244 as an authorized key. If the key 4 is not in the data storage 226 and therefore not an authorized key, then no further action is taken. If the key 4 is identified within the data storage 226, the system further verifies at step 246 if the key 4 passes conditional settings. Conditional settings may be such as, by way of non-limiting example, date or time access limitations, has not reached a maximum number of times used, etc. If the key does not pass the conditional settings at step 246, then no further action is taken. If the key does pass the conditional settings at step 246, then the solenoid 146 is activated at step 248, releasing the latch 144 and allowing the outer housing 80 to rotate within the base 32, thereby allowing the deadbolt 36 to unlock, as is commonly known in the art.

While specific embodiments of the invention have been described and illustrated, such embodiments should be considered illustrative of the invention only and not as limiting the invention as construed in accordance with the accompanying claims.

What is claimed is:

1. An apparatus for selectably unlocking a door comprising:
a base adapted to be mounted within a door;
an outer cylinder selectably rotatable relative to said base, said outer cylinder having an central bore therethrough;
an inner cylinder selectably rotatably received within said inner bore of said outer cylinder, said inner cylinder having a key slot therethrough, said inner cylinder being adapted to unlock a door upon rotation of said inner cylinder;
a plurality of tumblers extending between said inner and outer sleeves alignable upon insertion of a specific key within said key slot so as to permit rotation of said inner cylinder within said central bore;
a means for identifying a key inserted within said key slot as an authorized key; and
a latch operable to selectably couple said outer cylinder to said base wherein said latch uncouples said outer cylinder from said base when an authorized key is located within said key slot.

2. The apparatus of claim 1 wherein said inner and outer cylinders are rotatable about a common axis.

3. The apparatus of claim 1 wherein each of said plurality of tumblers comprise pin tumblers comprises a key pin located within a pin bore extending radially outward through said inner cylinder and a selectably alignable driver pin located within a driver pin bore extending radially inward into said central bore of said outer cylinder.

4. The apparatus of claim 3 wherein each key pin is displaceable by said key within said key slot.

5. The apparatus of claim 4 wherein said means for identifying comprises at least one sensor adapted to read a profile of said key inserted into said key slot.

6. The apparatus of claim 5 wherein said sensor comprise position sensors disposed on each driver pin to measure a position of said plurality of tumblers as determined by said profile of said key inserted into said key slot.

7. The apparatus of claim 1 further comprising a processing circuit having an associated memory, said processing circuit being adapted to:
receive said position of each of said at least one sensor;
compare said measured profile against a plurality of authorized key profiles contained within said associated memory; and
identify said key inserted within said key slot as an authorized key if said profile matches one of said plurality of authorized key profiles contained within said associated memory.

8. The apparatus of claim 7 wherein said processing circuit is further adapted to cause said latch to uncouple said outer cylinder and said base.

9. The apparatus of claim 8 wherein said latch comprises a pin slidably extendable from said base into a radial bore within said outer cylinder.

10. The apparatus of claim 9 wherein said latch includes a solenoid adapted to retract said pin from engagement within said radial bore upon receipt of a signal from said processing circuit indicating that said key is an authorized key.

11. The apparatus of claim 8 wherein said processing circuit is further adapted to cause said latch to uncouple said outer cylinder and said base only if all criteria for that authorized key are satisfied.

12. A method for selectably unlocking a lock comprising:
reading a key inserted into a slot within an inner cylinder wherein said inner cylinder is received within an outer cylinder supported by and selectably lockable relative to a base, wherein said inner cylinder is operably connected to a lock catch so as to cause said lock to be unlocked in response to rotation of said inner cylinder;
identifying said key as one of a specific key, an authorized key or an unauthorized key;
if said key is a specific key, permitting said inner cylinder to rotate relative to said outer cylinder, wherein said inner cylinder is rotatably fixed relative to said outer cylinder if said key is not a specific key;
if said key is an authorized key, permitting said outer cylinder to rotate relative to said base; and
rotatably fixing said inner cylinder and said outer cylinder to said base if said key is an unauthorized key.
